(19) United States
(12) Patent Application Publication
(10) Pub. No.: US 2018/0187771 A1
(43) Pub. Date: Jul. 5, 2018

(54) LUBRICATION SYSTEM FOR A GEARBOX OF A TRANSMISSION SYSTEM

(71) Applicant: Caterpillar Inc., Peoria, IL (US)

(72) Inventors: Trevor William Somers, Shorewood, IL (US); Carl John Moberg, Dunlap, IL (US); Dirk Voß, Menden (DE); Frank Karl Kuhnemund, Dresden (DE)

(73) Assignee: Caterpillar Inc., Peoria, IL (US)

(21) Appl. No.: 15/396,879

(22) Filed: Jan. 3, 2017

(51) Int. Cl. F16H 57/04; E21C 31/12

(52) U.S. Cl. CPC F16H 57/0435; E21C 31/12; F16H 57/0441; F16H 57/0436

(57) ABSTRACT

A lubrication system for a gearbox of a transmission system includes an outlet line that is configured to allow an egress of oil from the gearbox. The lubrication system also includes a scavenging pump that is fluidly coupled with the outlet line and configured to draw oil from the gearbox via the outlet line. The lubrication system further includes a pressure sensor that is disposed in the outlet line and located upstream of the scavenging pump. The pressure sensor is configured to measure a pressure of fluid entering the scavenging pump. The lubrication system further includes a controller that is communicably coupled to the pressure sensor and the scavenging pump. The controller is configured to vary a displacement of fluid from the scavenging pump based on a comparison of the pressure of fluid entering the scavenging pump as measured by the pressure sensor with at least one pre-determined threshold value.

### TECHNICAL FIELD

The present disclosure relates to a lubrication system for a transmission system of a machine. More particularly, the present disclosure relates to a method of controlling operation of a transmission system having a gearbox, and a lubrication system having a scavenging pump that is fluidly coupled to the gearbox.

### BACKGROUND

Many industrial machines generally employ a transmission system having a gearbox for operatively transmitting power from a prime mover to a work implement of the machine. An example of one such machine may include, but is not limited to, a hard rock roadheader that can be used to harvest mineral deposits, for example, hard rock seams present in the earth. These roadheaders are typically provided with a gearbox which facilitates the rotation of a cutting tool being mounted on a boom for performing a rock cutting operation.

As the gearbox may be subject to extreme operating conditions, the gearbox is replenished and scavenged with oil to accomplish lubrication between moving components of the gearbox and hence, achieve optimal operating performance from the gearbox. In most cases, a scavenging pump may be fluidly coupled downstream of the gearbox to accomplish the circulation of oil into and out of the gearbox. However, during an operation of the gearbox, a rate of oil exiting the gearbox may vary depending on one or more operating conditions of the gearbox. For example, during cold start conditions, it has been observed that the rate of oil exiting the gearbox may be scanty and hence, insufficient to facilitate operation of the scavenging pump downstream of the gearbox. Therefore, during such a cold start condition and a myriad of other conditions, it may be possible that the rate of oil exiting the gearbox may not correspond with a displacement of the scavenging pump and hence, cause a deterioration in the performance of the scavenging pump downstream of the gearbox.

Moreover, with variations in the speed of components present in the gearbox rotation during operation, suction lines associated with the scavenging pump may become fully or partially exposed to air thereby leading to oil aeration. It is well known in the art that over a prolonged period of time and use, aeration could lead to deterioration in the performance of the scavenging pump and may eventually cause failure of the scavenging pump. Furthermore, such conditions may pose various detrimental effects to pressure sensitive components such as seals, gaskets, and the like, if present, between the gearbox and the scavenging pump of the transmission system.

Hence, there exists a need for an improved system that facilitates lubrication of a given transmission system while also overcoming the aforementioned shortcomings.

### SUMMARY OF THE DISCLOSURE

In an aspect of the present disclosure, a lubrication system for a gearbox of a transmission system includes an outlet line that is configured to allow an egress of oil from the gearbox. The transmission system also includes a scavenging pump that is fluidly coupled with the outlet line and configured to draw oil out of the gearbox via the outlet line.

The lubrication system further includes a pressure sensor that is disposed in the outlet line and located upstream of the scavenging pump. The pressure sensor is configured to measure a pressure of fluid entering the scavenging pump. The lubrication system further includes a controller that is communicably coupled to the pressure sensor and the scavenging pump. The controller is configured to vary a displacement of fluid from the scavenging pump based on a comparison of the pressure of fluid entering the scavenging pump as measured by the pressure sensor with at least one pre-determined threshold value.

In another aspect of the present disclosure, a method for controlling operation of a transmission system having a gearbox and a lubrication system having a scavenging pump fluidly coupled to the gearbox includes operating the gearbox corresponding to a minimum threshold speed of a load being borne by the gearbox, and operating the scavenging pump coterminous with the operation of the gearbox. The method then includes measuring a pressure of fluid entering the scavenging pump, and varying a displacement of fluid from the scavenging pump on the basis of a comparison between the pressure of fluid entering the scavenging pump and at least one pre-determined threshold value.

Other features and aspects of this disclosure will be apparent from the following description and the accompanying drawings.

### BRIEF DESCRIPTION OF THE DRAWINGS

FIG. 1 is a perspective view of an exemplary machine, in which embodiments of the present disclosure may be implemented;

FIG. 2 is a schematic of a transmission system for the exemplary machine, in accordance with an embodiment of the present disclosure; and

FIG. 3 is a flowchart depicting a method for controlling operation of the transmission system, in accordance with an embodiment of the present disclosure.

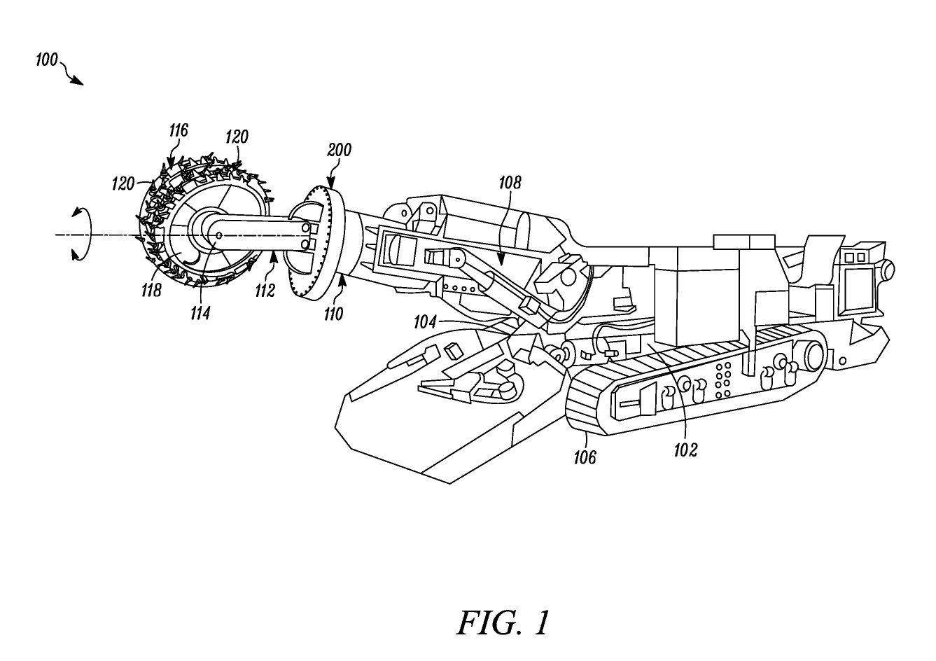

### DETAILED DESCRIPTION

Wherever possible, the same reference numbers will be used throughout the drawings to refer to the same or the like parts. Referring to FIG. 1, an exemplary machine 100 is illustrated. In the illustrated embodiment of FIG. 1, the machine 100 is embodied in the form of a hard rock roadheader that is typically used to harvest mineral deposits, for example, hard rock seams present in the earth. However, a type of machine 100 shown in the illustrated embodiment of FIG. 1 is merely exemplary in nature and hence, non-limiting of this disclosure. In other embodiments, other types of machines including, but not limited to, augers, tillers, and other large industrial machines may be employed in lieu of the hard rock roadheader disclosed herein. It will be appreciated by persons skilled in the art that systems and methods disclosed herein can be similarly applied on other types of machines having a transmission system therein.

As shown, the machine 100 includes a frame 102. The frame 102 may be movably supported on a pair of ground engaging members 104, 106 each of which is exemplarily embodied in the form of a crawler and shown in the illustrated embodiment of FIG. 1. However, it may be noted that in other embodiments, other types of ground engaging members including, but not limited to, wheels may be employed in lieu of the crawlers depending upon specific requirements of an application.

The machine 100 also includes a boom 108 that is pivotally coupled to the frame 102. The boom 108 has a first portion 110 and a second portion 112 that is rotatably coupled to the first portion 110. The second portion 112 is configured to rotate in relation to the first portion 110.

Moreover, a free end 114 of the second portion 112 is adapted to support a rotary cutting tool 116 thereon. As shown in the illustrated embodiment of FIG. 1, the rotary cutting tool 116 may be implemented by a rotary head 118 bearing a series of cutters 120 thereon. It may be noted that a configuration of the rotary cutting tool 116 disclosed in the illustrated embodiment of FIG. 1 is merely exemplary in nature and hence, non-limiting of this disclosure. Persons skilled in the art will acknowledge that the configuration of the rotary cutting tool 116 used on the machine 100 may vary from one application to another depending on a type of machine used and other specific requirements of an application.

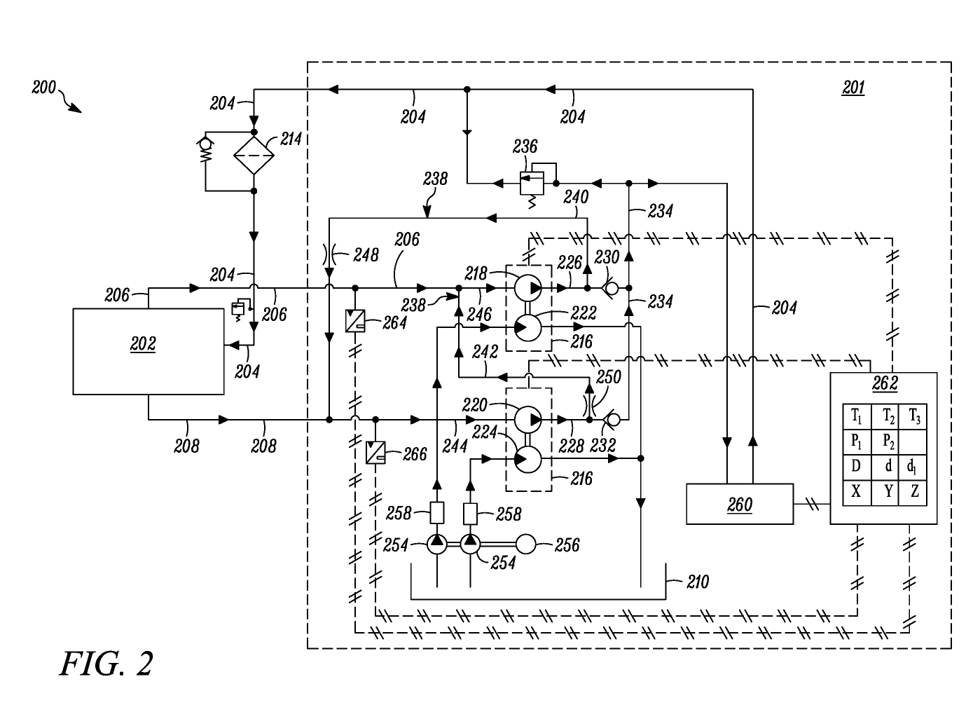

The present disclosure relates to a transmission system 200 that is configured to operatively rotate the rotary cutting tool 116 relative to the second portion 112 of the boom 108. As shown in the schematic illustration of FIG. 2, the transmission system 200 includes a gearbox 202 that is provided with an inlet line 204. The inlet line 204 is configured to supply fluid to the gearbox 202, for example, from a reservoir 210 via a main hydraulic pump 254 via a pair of corresponding electronically controlled hydraulic valves 258, the main hydraulic pump 254 being driven by a prime mover 256 e.g., an electric motor as shown in FIG. 2.

In an aspect, the present disclosure particularly relates to a lubrication system 201 for the gearbox 202 of the transmission system 200. As further shown in FIG. 2, the lubrication system 201 includes at least one outlet line that is fluidly coupled to the gearbox 202. In the illustrated embodiment of FIG. 2, a pair of outlet lines i.e., a first outlet line 206, and a second outlet line 208 that is disposed in parallel relation to the first outlet line 206 are provided for facilitating an egress of fluid out of the gearbox 202. Although a pair of outlet lines 204, 206 are disclosed herein, it may be noted that fewer or more number of outlet lines may be fluidly coupled to the gearbox 202 depending on specific requirements of an application.

In an embodiment, the inlet line 204 and the pair of outlet lines 206, 208 may be further configured to interface with a heat exchanger 260 that is operatively controlled by a controller 262 as shown in the illustrated embodiment of FIG. 2. It may be noted that the controller 262 is suitably provided with associated system hardware including, but not limited to, directional control valves for regulating a flow of oil from the gearbox to one or both of the reservoir 210 and the heat exchanger 260.

Moreover, it may be noted that although an electric motor is disclosed herein, other types of prime movers including, but not limited to, internal combustion engines may be used in lieu of the electric motor disclosed herein. Each of the first and second outlet lines 206, 208 is configured to allow egress of fluid from the gearbox 202 for achieving an optimal performance of the gearbox 202 during operation of the transmission system 200.

The lubrication system 201 further includes at least one pump-motor assembly 216, in this case—a pair of pump-motor assemblies 216 that are disposed in fluid communication with the gearbox 202 via respective ones of the first and second outlet lines 206, 208. The pump-motor assemblies 216 include a scavenging pump, in this case—a pair of scavenging pumps i.e., a first scavenging pump 218 and a second scavenging pump 220 to correspond with the pair of outlet lines 204, 206 respectively. Although two scavenging pumps 204, 206 are disclosed herein, it may be noted that, in other embodiments, fewer or more scavenging pumps may be used depending on a number of outlet lines being provided to the gearbox 202. With regards to the illustrated embodiment of FIG. 2, the first scavenging pump 218 is disposed in fluid communication with the first outlet line 206 and the second scavenging pump 220 is disposed in fluid communication with the second outlet line 208. Each of the first and second scavenging pumps 218, 220 is configured to operatively scavenge oil from the gearbox 202.

As shown in the illustrated embodiment of FIG. 2, the pump-motor assemblies 216 further include a pair of hydraulic motors i.e., a first hydraulic motor 222 and a second hydraulic motor 224 to correspond with respective ones of the pair of scavenging pumps 218, 220. The first hydraulic motor 222 is configured to operatively drive the first scavenging pump 218 and the second hydraulic motor 224 is configured to operatively drive the second scavenging pump 220. The pair of hydraulic motors 222, 224 may be driven using fluid pressurized from one or more driver hydraulic pumps 254 driven by power from the prime mover 256, or alternatively, via an auxiliary power source (not shown).

In an embodiment of this disclosure, each of the first and second scavenging pumps 218, 220 are embodied as fixed displacement gear pumps and the first and second hydraulic motors 222, 224 are fixed displacement gear motors. However, in other embodiments, persons skilled in the art may contemplate incorporating variable displacement pumps and motors in lieu of respective ones of the fixed displacement pumps and motors disclosed herein depending on specific requirements of an application.

Moreover, an outlet 226 of the first scavenging pump 218 and an outlet 228 of the second scavenging pump 220 are disposed in fluid communication with a first check valve 230 and a second check valve 232 respectively. As shown in the illustrated embodiment of FIG. 2, the lubrication system 201 further includes the main output line 234 which is located downstream of the first and second check valves 230, 232 and disposed in selective fluid communication with each of the first and second outlet lines 206, 208. The first and second check valves 230, 232 are configured to selectively allow a unidirectional flow of oil from respective ones of the first and second outlet lines 206, 208 into the main output line 234.

Furthermore, the lubrication system 201 also includes a pilot controlled relief valve 236 that is configured to selectively communicate fluid from the main output line 234 to the inlet line 204 associated with the gearbox 202. The relief valve 236 may be of a type that works on a spring-operated pilot relief setting. The relief valve 236 may be set to open at a pre-determined pressure value depending on specific requirements of an application.

The lubrication system 201 further includes an anti-aeration system 238 having a pair of intermediary fluid lines i.e., a first intermediary fluid line 240 and a second intermediary fluid line 242. The first intermediary fluid line 240 is configured to fluidly communicate oil from the outlet 226 of the first scavenging pump 218 to an inlet 244 of the second scavenging pump 220. The second intermediary fluid line 242 is configured to fluidly communicate oil from the outlet 228 of the second scavenging pump 220 to an inlet 246 of the first scavenging pump 218. As shown in the illustrated embodiment of FIG. 2, the anti-aeration system 238 also includes a first orifice 248 that is disposed in the first intermediary fluid line 240, and a second orifice 250 that is disposed in the second intermediary fluid line 242. The first and second orifices 248, 250 are configured to regulate a mass flow rate of the oil being pumped into the first and second intermediary fluid lines 240, 242 by respective ones of the first and second scavenging pumps 218, 220.

During operation, the gearbox 202 receives oil from the source through the inlet line 204 via a filtration device 214. This oil may heat up within the gearbox 202 depending on various operating conditions of the gearbox 202. The heated oil from the gearbox 202 may be scavenged by one or both scavenging pumps i.e., the first and/or second scavenging pumps 218, 220 depending on various factors including, but not limited to, an angle of the cutting tool 116 with respect to the frame 102 of the machine 100, a rotation angle of the second portion 112 of the boom 108 with respect to the first portion 110 of the boom 108, a speed of rotation of the second portion 112 of the boom 108, and the like.

While scavenging, if one of the scavenging pumps i.e., the first scavenging pump 218 or the second scavenging pump 220 begins to receive little or no oil from the gearbox 202, oil from the other scavenging pump i.e., the first scavenging pump 218 or the second scavenging pump 220 enters the first or the second intermediary fluid line 240, 242 to the scavenging pump i.e., the first scavenging pump 218 or the second scavenging pump 220 that begins to receive little or no oil from the gearbox 202.

For example, if the first scavenging pump 218 begins to receive little or no oil from the gearbox 202, oil from the outlet 228 of the second scavenging pump 220 may be routed through the second intermediary fluid line 242 to the inlet 246 of the first scavenging pump 218. Likewise, in another example, if the second scavenging pump 220 begins to receive little or no oil from the gearbox 202, oil from the outlet 226 of the first scavenging pump 218 may be routed through the first intermediary fluid line 240 to the inlet 244 of the second scavenging pump 220. Thus, a possibility of air entering the first or second scavenging pumps 218/220 may be reduced to minimize or prevent aeration from occurring in the first or second scavenging pumps 218/220.

Additionally, the lubrication system 201 also includes a pressure sensor. In the illustrated embodiment of FIG. 2, a pair of pressure sensors i.e., a first pressure sensor 264 and a second pressure sensor 266 are provided to correspond with the pair of outlet lines 206, 208 associated with the gearbox 202. As shown, the first pressure sensor 264 in disposed in the first outlet line 206 and located upstream of the first scavenging pump 218. Likewise, the second pressure sensor 266 in disposed in the second outlet line 206 and located upstream of the second scavenging pump 220. The first and second pressure sensors 264, 266 are configured to measure a pressure of fluid entering respective ones of the first and second scavenging pumps 218, 220.

Additionally, the controller 262 is communicably coupled to each of the first and pressure sensors 264, 266 and each of the first and second scavenging pumps 218, 220. The controller 262 is configured to vary a displacement of fluid from the first scavenging pump 218 based on a comparison of the pressure of fluid entering the first scavenging pump 218 as measured by the first pressure sensor 264 with at least one pre-determined threshold value. Likewise, the controller 262 is configured to vary a displacement of fluid from the second scavenging pump 220 based on a comparison of the pressure of fluid entering the second scavenging pump 220 as measured by the second pressure sensor 266 with the at least one pre-determined threshold value.

It may be noted that in embodiments of this disclosure, it is contemplated that at any given instant of time only one of the two outlet lines i.e., the first outlet line 206 or the second outlet line 208 is disposed in fluid communication with the sump (not shown) of the gearbox 202 and hence, only a corresponding one of the two scavenging pumps i.e., the first scavenging pump 218 or the second scavenging pump 220 is disposed in operation depending on the outlet line 206/208 that is currently disposed in fluid communication with the sump of the gearbox 202.

The present disclosure is explained in reference with an operation of the first scavenging pump 218 i.e., when the first outlet line 206 receives oil from the sump of the gearbox 202. However, it should be noted that a similar manner of operation is applicable in the case of the second scavenging pump 220 when the second scavenging pump 220 becomes operational corresponding with the second outlet line 208 receiving oil from the sump of the gearbox 202.

Moreover, it may be noted that in embodiments of this disclosure, the at least one pre-determined threshold value disclosed herein may include a plurality of pre-determined threshold values. As shown in the illustrated embodiment of FIG. 2, three pre-determined threshold values i.e., a first pre-determined threshold value, a second pre-determined threshold value, and a third pre-determined threshold value as shown in FIG. 2. Although the present disclosure is explained in reference to the aforementioned three pre-determined threshold values, in other embodiments, fewer or more threshold values may be implemented by the controller 262 depending on specific requirements of an application. The controller 262 is configured to compare the pressure of fluid entering the first scavenging pump 218 with each of these threshold values, and in response to which, the controller 262 may be configured to vary the displacement of fluid from the first scavenging pump 218. It should be noted that a manner of varying the displacement of fluid from the first scavenging pump 218 by the controller 262 as outlined in this disclosure can be similarly applied to control an operation of the second scavenging pump 220 when the second outlet line 208 begins to receive oil from the gearbox 202 and when the second scavenging pump 220 is subsequently rendered in its operational state by the controller 262.

In embodiments of this disclosure, it may be noted that the controller 262 disclosed herein may embody a single microprocessor or multiple microprocessors that include components for performing functions consistent with the present disclosure. Numerous commercially available microprocessors can be configured to perform the functions of the controller 262 disclosed herein. It should be appreciated that the controller 262 could readily be embodied in a general purpose microprocessor capable of controlling numerous functions associated with the transmission system 200 and the lubrication system 201. The controller 262 may also include a memory, a secondary storage device, and any other components for running an application. Various other circuits may be associated with the controller 262 such as power supply circuitry, signal conditioning circuitry e.g., an analog-to-digital converter circuitry, and other types of circuitry. Various routines, algorithms, and/or programs can be programmed within the controller 262 for execution thereof. Moreover, it should be noted that the controller 262 of the present disclosure may be a stand-alone processor or may be configured to co-operate with existing processor/s, for example, an electronic control module (ECM) (not shown) provided to the machine 100 to perform functions that are consistent with the present disclosure.

In an embodiment, the controller 262 is configured to delay an operation of the first scavenging pump 218 by a pre-defined amount of time ‘X’ if the pressure of fluid entering the first scavenging pump 218 is less than the first pre-determined threshold value T₁. It may be noted that the first pre-determined threshold value T₁ disclosed herein corresponds with a minimum flow rate of fluid supply required to facilitate operation of the first scavenging pump 218. In this embodiment, the controller 262 is configured to delay the operation of the first scavenging pump 218 by first terminating an operation of the first scavenging pump 218 for the pre-defined amount of time X and thereafter resuming operation of the first scavenging pump 218 upon lapse of the pre-defined amount of time X. The pre-defined amount of time X disclosed herein is coterminous with an amount of time required by the fluid upstream of the first scavenging pump 218 i.e., in the first outlet line 206 to reach the first pre-determined threshold value T₁.

For example, during operation of the transmission system 200, if the first pre-determined threshold value T₁ is set at the controller 262 to a pressure value of −30 kPa (kilo-Pascal), and a current pressure of fluid in the first outlet line 206 is less than −30 kPa, say −35 kPa, then the controller 262 may delay an operation of the first scavenging pump 218 for a pre-defined amount of time X, say 30 seconds, by terminating the operation of the first scavenging pump 218 for the pre-defined amount of time X i.e., 30 seconds before resuming an operation of the first scavenging pump 218.

Additionally or optionally, at any instant of time during the pre-defined amount of time X, for which the delay is being implemented in the operation of the first scavenging pump 218, if the controller 262 obtains a measurement of the pressure of fluid P₁ in the first outlet line 206 from the first pressure sensor 264 that is indicative of the pressure of fluid P₁ in the first outlet line 206 being greater than the first pre-determined threshold value T₁, then the controller 262 may countermand the delay and allow the first scavenging pump 218 to resume operation, preferably, with a displacement value that is commensurate with the pressure of fluid in the first outlet line 206.

In another embodiment, the controller 262 is configured to reduce the displacement of fluid from the first scavenging pump 218 if the pressure of fluid P₁ entering the first scavenging pump 218 is between the first pre-determined threshold value T₁ and the second pre-determined threshold value T₂. It may be noted that the second pre-determined threshold value T₂ disclosed herein is greater than the first pre-determined threshold value T₁. In an example, if the first pre-determined threshold value T₁ and the second pre-determined threshold value T₂ are set at the controller 262 to pressure values of −30 kPa and −20 kPa respectively, and if a current pressure of fluid in the first outlet line 206 is −25 kPa, then the controller 262 may be configured to reduce the displacement of fluid from the first scavenging pump 218.

Additionally, in a further embodiment, when the pressure of fluid P₁ entering the first scavenging pump 218 is between the first pre-determined threshold value T₁ and the second pre-determined threshold value T₂, the controller 262 may also be configured to reduce the displacement of fluid from the first scavenging pump 218 by a pre-defined amount ‘Y’ that is commensurate with a difference between the current displacement of fluid from the first scavenging pump 218 and the minimum rated displacement value associated with the first scavenging pump 218.

Denoting the current displacement of fluid from the first scavenging pump 218 as ‘D’ and the minimum rated displacement value associated with the first scavenging pump 218 as ‘d’, a relation between the reduction in the displacement of fluid from the first scavenging pump 218 by the pre-defined amount ‘Y’, the current displacement of fluid ‘D’ from the first scavenging pump 218, and the minimum rated displacement value ‘d’ associated with the first scavenging pump 218 can be given by equation 1 as follows:

Y∝|D−d| eq. 1.

Additionally or optionally, in a further embodiment, the controller 262 may also be configured to repeatedly reduce the displacement of fluid ‘D’ from the first scavenging pump 218 until the displacement of fluid ‘D’ from the first scavenging pump 218 reaches the minimum rated displacement value ‘d’ associated with the first scavenging pump 218. With regards the foregoing example, if the first pre-determined threshold value T₁ and the second pre-determined threshold value T₂ are set at the controller 262 to pressure values of −30 kPa and −20 kPa respectively, the current pressure of fluid P₁ in the first outlet line 206 as measured by the first pressure sensor 264 is −25 kPa, the current displacement of fluid ‘D’ from the first scavenging pump 218 as measured by the first pressure sensor 264 is 50 L/min (liters per min), and the minimum rated displacement value ‘d’ associated with the first scavenging pump 218 is 25 L/min, then the controller 262 may be configured to repeatedly reduce the displacement of fluid ‘D’ from the first scavenging pump 218 from 50 L/min (liters per min) by 0.25 L/sec (liters per second) each time until the current displacement ‘D’ of the fluid from the first scavenging pump 218 i.e., 50 L/min is reduced to the minimum rated displacement value ‘d’ i.e., 25 L/min associated with the first scavenging pump 218.

In another embodiment, the controller 262 is configured to maintain the displacement of fluid from the first scavenging pump 218 at its current value ‘D’ if the pressure of fluid P₁ entering the first scavenging pump 218 is between the second pre-determined threshold value T₂ and a third pre-determined threshold value T₃, the third pre-determined threshold value T₃ being greater than the second pre-determined threshold value T₂ disclosed herein. With regards to the foregoing example, if the second pre-determined threshold value T₂ and the third pre-determined threshold value T₃ are set at the controller 262 to pressure values of −20 kPa and −10 kPa respectively, and if the current pressure of fluid P₁ in the first outlet line 206 as measured by the first pressure sensor 264 is −15 kPa, then the controller 262 may be configured to maintain the displacement of fluid ‘D’ from the first scavenging pump 218 at its current value ‘D’ i.e., 50 L/min.

In yet another embodiment, the controller is configured to increase the displacement of fluid ‘D’ from the first scavenging pump 218 if the pressure of fluid P₁ entering the first scavenging pump 218 is greater than the third pre-determined threshold value T₃. In relation to the foregoing example, if the third pre-determined threshold value T₃ is set at the controller 262 to a pressure value of −10 kPa, and if a current pressure of fluid P₁ in the first outlet line 206 as measured by the first pressure sensor 264 is 10 kPa, then the controller 262 may be configured to increase the displacement of fluid ‘D’ from the first scavenging pump 218.

Additionally, in a further embodiment, when the pressure of fluid P₁ entering the first scavenging pump 218 is greater than the third pre-determined threshold value T₃, the controller 262 may also be configured to increase the displacement of fluid ‘D’ from the first scavenging pump 218 by a pre-defined amount ‘Z’ that is commensurate with a difference between the current displacement of fluid ‘D’ from the first scavenging pump 218 and a maximum rated displacement value ‘d₁’ associated with the first scavenging pump 218. A relation between the increase in the displacement of fluid ‘D’ from the first scavenging pump 218 by the pre-defined amount ‘Z’, the current displacement of fluid ‘D’ from the first scavenging pump 218, and the maximum rated displacement value ‘d₁’ associated with the first scavenging pump 218 can be given by equation 2 as follows:

Z∝|D−d₁| eq. 2.

Additionally or optionally, in a further embodiment, when the pressure of fluid P₁ entering the first scavenging pump 218 is greater than the third pre-determined threshold value T₃, the controller 262 may also be configured to repeatedly increase the displacement of fluid ‘D’ from the first scavenging pump 218 until the displacement of fluid ‘D’ from the first scavenging pump 218 reaches the maximum rated displacement value ‘d₁’ associated with the first scavenging pump 218. With regards the foregoing example, if the third pre-determined threshold value T₃ is set at the controller 262 to a pressure values of −10 kPa, the current pressure of fluid P₁ in the first outlet line 206 as measured by the first pressure sensor 264 is 10 kPa, the current displacement of fluid ‘D’ from the first scavenging pump 218 as measured by the first pressure sensor 264 is 50 L/min (liters per min), and the maximum rated displacement value ‘d’ associated with the first scavenging pump 218 is 100 L/min, then the controller 262 may be configured to repeatedly increase the displacement of fluid ‘D’ from the first scavenging pump 218 from 50 L/min (liters per min) by 0.5 L/sec (liters per second) each time until the current displacement ‘D’ of the fluid from the first scavenging pump 218 i.e., 50 L/min is increased to the maximum rated displacement value ‘d₁’ i.e., 100 L/min associated with the first scavenging pump 218.

It may be noted that the controller 262 of the present disclosure can be configured to determine the pressure of fluid P₁ upstream of the first scavenging pump 218 i.e., in the first outlet line 206 from the first pressure sensor 264 at pre-defined periodic intervals for e.g., every 2 s (seconds), or in a continuous manner so as to facilitate an almost real-time, or indeed a real-time control in the displacement of the first scavenging pump 218 based on the pressure of fluid P₁ upstream of the first scavenging pump 218 i.e., in the first outlet line 206.

Embodiments of the foregoing disclosure can be used to implement a similar manner of operation in regards to the displacement of fluid from the second scavenging pump 220 whose inlet pressure reading is denoted by alphanumerical ‘P₂’ in the illustrated embodiment of FIG. 2. Moreover, it may be further noted that the each of first scavenging pump 218 and the second scavenging pump 220 may be provided with suitable system hardware (not shown) including, but not limited to, flow control valves, direction control valves and the like that can be commanded for operation by the controller 262 to accomplish a variation in the displacement of fluid from respective ones of the first and second scavenging pumps 218, 220. It will also be appreciated by persons skilled in the art that the variation in the displacement ‘D’ of fluid from respective ones of the first and second scavenging pumps 218, 220 can be accomplished by the controller 262 in any manner including, but not limited to, electrically, mechanically, hydraulically, hydro-mechanically, or other suitable combinations thereof depending on specific system configurations of the hardware being implemented for use in the lubrication system 201 and the transmission system 200.

Various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

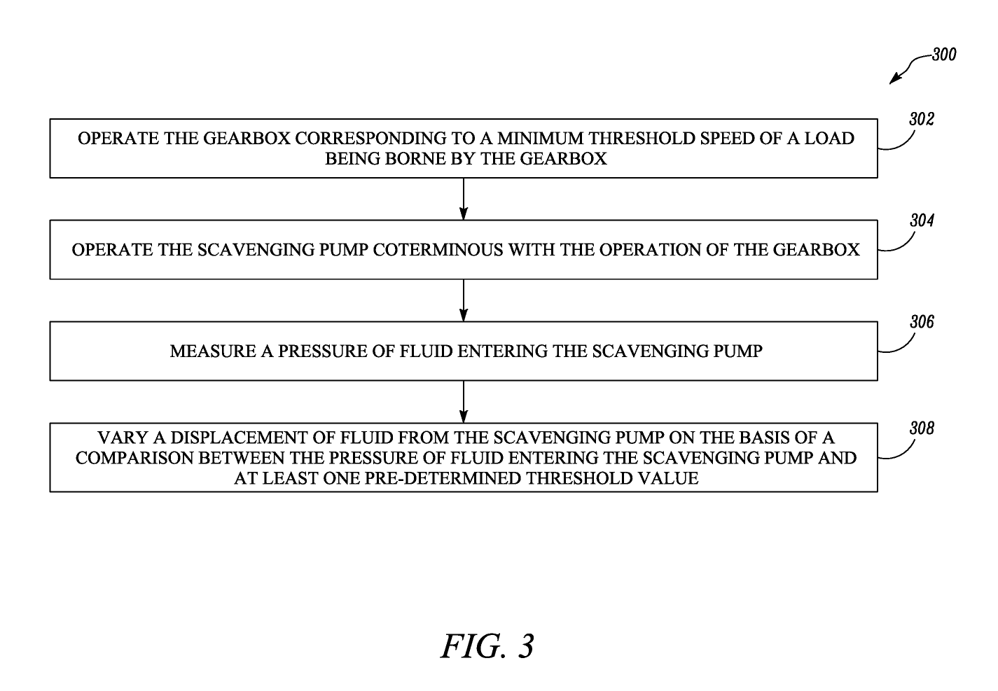

Referring to FIG. 3, a method 300 for controlling operation of the transmission system 200 and the lubrication system 201 includes operating the gearbox 202 corresponding to a minimum threshold speed of a load being borne by the gearbox, for example, the minimum threshold speed of the cutting tool 116 mounted to the second portion 112 of the boom 108. At step 304, the method 300 further includes operating the scavenging pump i.e., the first scavenging pump 218 or the second scavenging pump 220 coterminous with the operation of the gearbox 202. At step 306, the method 300 further includes measuring a pressure of fluid P₁/P₂ entering the scavenging pump i.e., the first scavenging pump 218 or the second scavenging pump 220. At step 308, the method 300 further includes varying a displacement of fluid ‘D’ from the scavenging pump i.e., the first or second scavenging pumps 218/220 on the basis of a comparison between the pressure of fluid P₁/P₂ entering the scavenging pump i.e., respective operational ones of the first and second scavenging pumps 218, 220 and the at least one pre-determined threshold value i.e., one or more of the first, second, and third pre-determined threshold values T₁, T₂, and/or T₃ disclosed herein.

The present disclosure has applicability for use and implementation in minimizing the possibility of aeration from occurring at scavenging pumps present in one or more hydraulic circuits of a gearbox. As known to persons skilled in the art, scavenging pumps are typically prone to deterioration in performance with the occurrence of aeration within the scavenging pumps. Furthermore, such conditions may deteriorate various types of pressure sensitive components such as seals, gaskets and the like, if present, between the gearbox of the transmission system and the scavenging pump of the lubrication system.

With use of embodiments disclosed herein, manufacturers can build transmission systems that allow efficient cooling of an associated gearbox while minimizing aeration issues typically experienced by scavenging pumps of conventional cooling circuits present in previously known transmission systems. With implementation of the first and second intermediary fluid lines 240, 242 disclosed herein, oil is routed to either of the first or second scavenging pumps 218, 220 to prevent air from entering the first and second scavenging pumps 218, 220 thereby minimizing or preventing aeration from occurring in the first and second scavenging pumps 218, 220. Moreover, as the displacement of fluid from the first and second scavenging pumps 218, 220 can be independently varied by the controller 262 to correspond with the pressure of fluid P₁, P₂ upstream of respective ones of the first and second scavenging pumps 218, 220, the transmission system 200 can be operated to optimally meet system requirements of the machine 100 during operation. This way, a service life of the scavenging first and second scavenging pumps 218, 220 may be prolonged leading to reduced maintenance costs with use of the transmission system 200. Further, users of the machine 100 may beneficially entail reduced costs, time, and effort required in the servicing or replacement of scavenging pumps and other pressure sensitive components e.g., seals (not shown) present between the gearbox 202 and respective ones of the scavenging pumps 218, 220, that are typically implemented for use in transmission systems.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A lubrication system for a gearbox of a transmission system, the lubrication system comprising:
at least one outlet line fluidly coupled to a the gearbox, the at least one outlet line configured to allow an egress of oil from the gearbox;
a scavenging pump fluidly coupled with the outlet line, the scavenging pump configured to draw oil out of the gearbox via the outlet line;
a pressure sensor disposed in the outlet line and located upstream of the scavenging pump, the pressure sensor being configured to measure a pressure of fluid entering the scavenging pump; and
a controller communicably coupled to the pressure sensor and the scavenging pump, wherein the controller is configured to vary a displacement of fluid from the scavenging pump based on a comparison of the pressure of fluid entering the scavenging pump as measured by the pressure sensor with at least one pre-determined threshold value.

2. The lubrication system of claim 1, wherein the controller is configured to delay an operation of the scavenging pump by a pre-defined amount of time if the pressure of fluid entering the scavenging pump is less than a first pre-determined threshold value, wherein the first pre-determined threshold value is coterminous with a minimum flow rate of fluid supply required to facilitate operation of the scavenging pump.

3. The lubrication system of claim 2, wherein the controller is configured to delay the operation of the scavenging pump by terminating an operation of the scavenging pump for the pre-defined amount of time and resuming operation of the scavenging pump upon lapse of the pre-defined amount of time, the pre-defined amount of time being coterminous to an amount of time required by the fluid upstream of the scavenging pump to reach the first pre-determined threshold value.

4. The lubrication system of claim 2, wherein the controller is configured to reduce the displacement of fluid from the scavenging pump if the pressure of fluid entering the scavenging pump is between the first pre-determined threshold value and a second pre-determined threshold value, the second pre-determined threshold value being greater than the first pre-determined threshold value.

5. The lubrication system of claim 4, wherein the controller is configured to reduce the displacement of fluid from the scavenging pump until the displacement of fluid from the scavenging pump reaches a minimum rated displacement value associated with the scavenging pump.

6. The lubrication system of claim 5, wherein the controller is configured to reduce the displacement of fluid from the scavenging pump by a pre-defined amount commensurate with a difference between the current displacement of fluid from the scavenging pump and the minimum rated displacement value associated with the scavenging pump.

7. The lubrication system of claim 4, wherein the controller is configured to maintain the displacement of fluid from the scavenging pump at its current value if the pressure of fluid entering the scavenging pump is between the second pre-determined threshold value and a third pre-determined threshold value, the third pre-determined threshold value being greater than the second pre-determined threshold value.

8. The lubrication system of claim 7, wherein the controller is configured to increase the displacement of fluid from the scavenging pump if the pressure of fluid entering the scavenging pump is greater than the third pre-determined threshold value.

9. The lubrication system of claim 8, wherein the controller is configured to increase the displacement of fluid from the scavenging pump until the displacement of fluid from the scavenging pump reaches a maximum rated displacement value associated with the scavenging pump.

10. The lubrication system of claim 9, wherein the controller is configured to increase the displacement of fluid from the scavenging pump by a pre-defined amount that is commensurate with a difference between the current displacement of fluid from the scavenging pump and the maximum rated displacement value associated with the scavenging pump.

11. A machine employing the lubrication system of claim 1, wherein the machine is a hard rock roadheader.

12. A method of controlling operation of a transmission system having a gearbox and a lubrication system having a scavenging pump fluidly coupled to the gearbox, the scavenging pump being located downstream of the gearbox, the method comprising:
operating the gearbox corresponding to a minimum threshold speed of a load being borne by the gearbox;
operating the scavenging pump coterminous with the operation of the gearbox;
measuring a pressure of fluid entering the scavenging pump; and
varying a displacement of fluid from the scavenging pump on the basis of a comparison between the pressure of fluid entering the scavenging pump and at least one pre-determined threshold value.

13. The method of claim 12 further comprising determining if the pressure of fluid entering the scavenging pump is less than a first pre-determined threshold value, the first pre-determined threshold value being coterminous with a minimum flow rate of fluid supply required to facilitate operation of the scavenging pump, and if so:
terminate operation of the scavenging pump for a pre-defined amount of time; and
resume operation of the scavenging pump upon lapse of the pre-defined amount of time.

14. The method of claim 13, wherein the pre-defined amount of time is coterminous with an amount of time required by the fluid upstream of the scavenging pump to reach the first pre-determined threshold value.

15. The method of claim 13 further comprising determining if the pressure of fluid entering the scavenging pump is between the first pre-determined threshold value and a second pre-determined threshold value, the second pre-determined threshold value being greater than the first pre-determined threshold value, and if so:
reduce the displacement of fluid from the scavenging pump until the displacement of fluid from the scavenging pump reaches a minimum rated displacement value associated with the scavenging pump.

16. The method of claim 15, wherein the displacement of fluid from the scavenging pump is reduced by a pre-defined amount that is commensurate with a difference between the current displacement of the scavenging pump and the minimum rated displacement value associated with the scavenging pump.

17. The method of claim 15 further comprising determining if the pressure of fluid entering the scavenging pump is between the second pre-determined threshold value and a third pre-determined threshold value, the third pre-determined threshold value being greater than the second pre-determined threshold value, and if so:
maintain the displacement of fluid from the scavenging pump at its current value.

18. The method of claim 17 further comprising determining if the pressure of fluid entering the scavenging pump is greater than the third pre-determined threshold value, and if so:
increase the displacement of fluid from the scavenging pump.

19. The method of claim 18, wherein the displacement of fluid from the scavenging pump is increased until the displacement of fluid from the scavenging pump reaches a maximum rated displacement value associated with the scavenging pump.

20. The method of claim 19, wherein the displacement of fluid from the scavenging pump is increased by a pre-defined amount that is commensurate with a difference between a current displacement of fluid from the scavenging pump and the maximum rated displacement value associated with the scavenging pump.
